(19) United States
(12) Patent Application Publication
(10) Pub. No.: US 2014/0209593 A1
(43) Pub. Date: Jul. 31, 2014

(54) PRESSURE-SENSITIVE ADHESIVE FORCE EXPRESSING UNIT, PRESSURE-SENSITIVE ADHESIVE LABEL ISSUING DEVICE, AND PRINTER

(71) Applicant: Seiko Instruments Inc., Chiba-shi (JP)

(72) Inventors: Yoshinori SATO, Chiba-shi (JP); Kazuo TANI, Chiba-shi (JP); Koichi HATAKEYAMA, Chiba-shi (JP)

(73) Assignee: Seiko Instruments Inc., Chiba-shi (JP)

(21) Appl. No.: 14/167,257

(22) Filed: Jan. 29, 2014

(30) Foreign Application Priority Data
Jan. 30, 2013 (JP) 2013-016112

(51) Int. Cl. B65C 9/25

(52) U.S. Cl. CPC B65C 9/25
USPC 219/216; 219/538

(57) ABSTRACT

A pressure-sensitive adhesive force expressing unit including: a thermal head including heater elements arranged along a width direction of a label, the thermal head being configured to heat the label, from an adhesive layer side to form openings in a function layer by the heater elements; and a controller for applying heat energy to the heater elements individually to control heat generation thereof, the controller being configured to control the application of heat energy to the heater elements so that opening lines in each of which the openings are arranged in the width direction of the label are formed in the conveyance direction and to control the application of heat energy so that adjacent at least two of the heater elements generate heat at the same time to form an opening group in which the openings are connected together in the width direction.

### RELATED APPLICATIONS

This application claims priority under 35 U.S.C. §119 to Japanese Patent Application No. 2013-016112 filed on Jan. 30, 2013, the entire content of which is hereby incorporated by reference.

### BACKGROUND OF THE INVENTION

1. Field of the Invention

The present invention relates to a pressure-sensitive adhesive force expressing unit for expressing pressure-sensitive adhesive force on a pressure-sensitive adhesive label, and to a pressure-sensitive adhesive label issuing device and a printer including the pressure-sensitive adhesive force expressing unit.

2. Description of the Related Art

Hitherto, pressure-sensitive adhesive labels have been used for, for example, a POS label for foods, a logistics/transportation label, a medical label, a baggage tag, and an indication label for bottles and cans. A widely known example is a pressure-sensitive adhesive label that has a recording surface (printing surface) formed on a front surface of a base, a pressure-sensitive adhesive layer formed on a rear surface of the base, and release paper (separator) covering the pressure-sensitive adhesive layer. Thus, when the pressure-sensitive adhesive label of this type is used, it is necessary to release the release paper from the pressure-sensitive adhesive layer after predetermined information such as a bar code or a price is printed on the recording surface. It is, however, actually difficult to recover and recycle the released release paper, and hence there is a problem in that the release paper becomes an industrial waste.

To address the problem, in recent years, a pressure-sensitive adhesive label that does not use release paper has come to be used from the viewpoint of environment protection and reduction in environmental burdens. For example, there has been known a pressure-sensitive adhesive label in which a release agent such as a silicon resin is applied onto a recording surface so that release properties between the recording surface and a pressure-sensitive adhesive layer can be secured even when the pressure-sensitive adhesive label is rolled into a roll. Further, there has been known another pressure-sensitive adhesive label in which a thermally active pressure-sensitive adhesive layer that expresses pressure-sensitive adhesiveness by heating is used as a pressure-sensitive adhesive layer. In addition, there has been proposed a pressure-sensitive adhesive label in which the entire surface of a pressure-sensitive adhesive layer is covered by a non-pressure-sensitive-adhesive resin layer and which is designed so that the resin layer is heated to form minute openings (bores) therein, to thereby expose the pressure-sensitive adhesive layer to express pressure-sensitive adhesiveness.

Of those, the pressure-sensitive adhesive label in which the pressure-sensitive adhesive layer is covered by the non-pressure-sensitive-adhesive resin layer is advantageous in that pressure-sensitive adhesive force can be easily and freely controlled by, for example, freely controlling where to form the openings in the resin layer so as to express pressure-sensitive adhesiveness only in a necessary region or conversely reducing the opening forming region so as to decrease the pressure-sensitive adhesive force. In this case, the effective means for heating the above-mentioned resin layer to form the openings is a thermal head in which a plurality of heat generating elements are arranged in line (linearly). This is because such a thermal head is capable of selectively controlling only desired heat generating elements to generate heat and thereby freely controlling the formation positions of the above-mentioned openings.

By the way, in the case where the heat generating element is used to form an opening in the resin layer, the resin layer is melted by heat generated by the heat generating element, and the melted region spreads to the periphery from a center part of the heat generating element in a concentric pattern, with the result that an opening is formed. Thus, if the resin layer is heated over a wide area or over the entire surface, the melted region cannot spread to the periphery but remains all over the place in the opening portion as a lump. In this case, the lump is thick and is thus responsible for hindering the contact to the pressure-sensitive adhesive layer, which decreases pressure-sensitive adhesive performance of the pressure-sensitive adhesive label.

Then, as a countermeasure against this problem, the following method has been known. As illustrated in FIG. 15, in order that a plurality of lines in each of which openings 101 are arranged in a width direction W of a pressure-sensitive adhesive label 100 may be formed in a conveyance direction F of the pressure-sensitive adhesive label 100 (label feed direction), the heat generating elements arranged in line are controlled to generate heat alternately for each line of the openings 101, and the heat generating elements are controlled to generate heat alternately for adjacent lines of the openings 101. With this method, the openings 101 can be formed in a checkered pattern, and hence a non-heating region 102 can be secured at the periphery of each opening 101. In this manner, in forming the opening 101, the melted resin layer 103 can be allowed to more easily spread to the periphery of the opening 101, to thereby suppress the decrease in pressure-sensitive adhesive performance. Note that, when the openings 101 are formed, the pressure-sensitive adhesive layer 104 is exposed to express pressure-sensitive adhesive force.

However, as illustrated in FIG. 16, the heat generating element 110 included in the thermal head generally has a rectangular shape, and hence the heat generating element 110 has such temperature characteristics that a center part of the rectangle is a peak part 110a having the highest temperature and the temperature gradually decreases toward the outer side of the concentric pattern (circular convex temperature characteristics). Thus, in the case where the openings 101 are formed in the checkered pattern illustrated in FIG. 15, an opening ratio of each opening 101 is inevitably apt to be small in practice. Consequently, a large gap T is formed between the openings 101, and hence the exposed pressure-sensitive adhesive layers 104 are excessively separated from one another, which still easily decreases the pressure-sensitive adhesive performance.

If the amount of energy to be applied to the heat generating element 110 is increased in order to increase the above-mentioned opening ratio, each opening 101 is sized up (increased in diameter) as illustrated in FIG. 17. Thus, the gap T between the openings 101 is extremely narrowed in contrast to the above-mentioned case. In this case, however, the strength of the resin layer 103 is reduced to easily cause tear. If the resin layer 103 is torn, the torn parts overlap one another to remain as a lump, which is responsible for hindering the contact to the pressure-sensitive adhesive layer 104.

Note that, it is presumed that the reason why the tear occurs is that, when the thermal head transfers heat to the resin layer 103 by sliding motion, the resin layer 103 is pulled and dragged relatively by the thermal head to be torn off.

### SUMMARY OF THE INVENTION

From the foregoing, in this technical field, demands have been made for a pressure-sensitive adhesive force expressing unit capable of melting a function layer (resin layer) that covers a pressure-sensitive adhesive layer at a sufficient opening ratio so as to express stable and sufficient pressure-sensitive adhesive force while suppressing tear of the function layer, and for a pressure-sensitive adhesive label issuing device and a printer including the pressure-sensitive adhesive force expressing unit.

According to one embodiment of the present invention, there is provided a pressure-sensitive adhesive force expressing unit that is configured to heat a pressure-sensitive adhesive label to express pressure-sensitive adhesive force thereof, the pressure-sensitive adhesive label including a printable layer and a pressure-sensitive adhesive layer, the printable layer being provided on one surface of a base, the pressure-sensitive adhesive layer being provided on another surface of the base and covered by a non-pressure-sensitive-adhesive function layer, the pressure-sensitive adhesive force expressing unit including: a thermal head including a plurality of heat generating elements arranged along a width direction of the pressure-sensitive adhesive label, the thermal head being configured to heat the pressure-sensitive adhesive label, which is conveyed along a conveyance direction, from the pressure-sensitive adhesive layer side to form openings in the non-pressure-sensitive-adhesive function layer by the plurality of heat generating elements and expose the pressure-sensitive adhesive layer; and a control unit for applying heat energy to the plurality of heat generating elements individually to control heat generation thereof, the control unit being configured to control the application of heat energy to the plurality of heat generating elements so that a plurality of opening lines in each of which the openings are arranged in the width direction of the pressure-sensitive adhesive label are formed in the conveyance direction and to control, in order to form each of the plurality of opening lines, the application of heat energy so that adjacent at least two of the plurality of heat generating elements generate heat at the same time to form an opening group in which the openings are connected together in the width direction.

According to the pressure-sensitive adhesive force expressing unit according to one embodiment of the present invention, in order to form each opening line, the control unit controls the application of heat energy so that adjacent at least two of the plurality of heat generating elements generate heat at the same time to form the opening group in which the openings are connected together in the width direction of the pressure-sensitive adhesive label. With this configuration, the temperature at an intermediate point located between the heat generating elements applied with heat energy can be increased owing to the effect of interaction of an increase in temperature of the respective heat generating elements. With this configuration, not only the region of the function layer in contact with the heat generating elements applied with heat energy but also the region of the function layer in contact with the above-mentioned intermediate point can be melted. Thus, even without increasing the amount of heat energy to be applied, the function layer can be melted in a wide area, and the opening group having a large opening ratio in which the openings are connected together in the width direction can be formed.

Consequently, the function layer can be melted locally at a sufficient opening ratio to expose the pressure-sensitive adhesive layer. Further, it is not necessary to increase the amount of heat energy to be applied to the heat generating elements, and hence the function layer provided at the periphery of the opening group can be prevented from being excessively melted. Thus, the strength of the function layer can be secured to suppress the occurrence of tear. In view of the above, stable and sufficient pressure-sensitive adhesive force can be expressed. Consequently, the pressure-sensitive adhesive label can be stably adhered even with a low pressing force.

In the pressure-sensitive adhesive force expressing unit according to one embodiment of the present invention, it is preferred that the control unit be configured to control the application of heat energy to the plurality of heat generating elements so that the opening groups are formed in a state in which each of the opening groups is connected to an opening group formed in a preceding opening line in the conveyance direction.

In this case, a larger opening ratio of the opening group can be secured, and hence more stable pressure-sensitive adhesive force can be expressed.

In the pressure-sensitive adhesive force expressing unit according to one embodiment of the present invention, it is preferred that the control unit be configured to control the application of heat energy to the plurality of heat generating elements so that the opening groups and non-opening parts are arranged alternately in both the width direction and the conveyance direction.

In this case, for example, the opening groups can be formed over the entire surface of the function layer in a checkered pattern, and hence the stable and sufficient pressure-sensitive adhesive force can be uniformly expressed over the entire pressure-sensitive adhesive label. Consequently, the quality as a pressure-sensitive adhesive label can be enhanced. Further, the number of times of heat generation can be made equal among the plurality of heat generating elements, and hence the non-uniformity of the life among the heat generating elements can be eliminated, and the reliability of the operation of the pressure-sensitive adhesive force expressing unit can be improved.

In the pressure-sensitive adhesive force expressing unit according to one embodiment of the present invention, it is preferred that the control unit be configured to control the application of heat energy to the plurality of heat generating elements so that adjacent ones of the opening groups are spaced apart from each other by 20 μm or more.

In this case, because adjacent ones of the opening groups can be spaced apart from each other by 20 μm or more, higher strength of the function layer can be secured, and such a problem that the function layer is torn off when sliding with respect to the thermal head during the conveyance of the pressure-sensitive adhesive label can be easily prevented.

A pressure-sensitive adhesive label issuing device according to one embodiment of the present invention includes: the pressure-sensitive adhesive force expressing unit according to one embodiment of the present invention; and a cutter unit for cutting the pressure-sensitive adhesive label to a desired length.

According to the pressure-sensitive adhesive label issuing device according to one embodiment of the present invention, the pressure-sensitive adhesive label can be cut to a desired length by the cutter unit, and hence a high quality pressure-sensitive adhesive label can be issued.

A printer according to one embodiment of the present invention includes: the pressure-sensitive adhesive label issuing device according to one embodiment of the present invention; and a printing unit placed on an upstream side of the pressure-sensitive adhesive force expressing unit in the conveyance direction, for printing on the printable layer.

According to the printer according to one embodiment of the present invention, desired information can be printed on the printable layer stably before pressure-sensitive adhesive force is expressed by the pressure-sensitive adhesive force expressing unit, and hence a high quality pressure-sensitive adhesive label in which various kinds of information are clearly printed and stable and sufficient pressure-sensitive adhesive force is expressed can be obtained.

According to one embodiment of the present invention, the function layer that covers the pressure-sensitive adhesive layer can be melted at a sufficient opening ratio so as to express stable and sufficient pressure-sensitive adhesive force while the tear of the function layer is suppressed.

### BRIEF DESCRIPTION OF THE DRAWINGS

FIG. 1 is a configuration diagram of a pressure-sensitive adhesive label issuing device including a pressure-sensitive adhesive force expressing unit according to a first embodiment of the present invention.

FIGS. 2A and 2B are enlarged cross-sectional views of a pressure-sensitive adhesive label illustrated in FIG. 1.

FIG. 3 is a plan view of a thermal head of the pressure-sensitive adhesive force expressing unit illustrated in FIG. 1.

FIG. 4 is a cross-sectional view of the thermal head illustrated in FIG. 3 taken long the line A-A.

FIG. 5 is an enlarged plan view of an electrode portion and heat generating elements of the thermal head illustrated in FIG. 3.

FIG. 6 is a block diagram of the pressure-sensitive adhesive force expressing unit illustrated in FIG. 1.

FIG. 7 is a plan view of the pressure-sensitive adhesive label, illustrating a state in which opening groups are formed in a function layer to express pressure-sensitive adhesive force.

FIG. 8 is a graph showing a relationship between a temperature tendency of heat generating dots in the line B-B illustrated in FIG. 7 and the shape of the opening group.

FIG. 9 is a plan view of the pressure-sensitive adhesive label, illustrating a modified example of layout of the opening groups formed in the function layer.

FIG. 10 is a plan view of the pressure-sensitive adhesive label, illustrating another modified example of the layout of the opening groups formed in the function layer.

FIG. 11 is a plan view of the pressure-sensitive adhesive label, illustrating another modified example of the layout of the opening groups formed in the function layer.

FIG. 12 is a plan view of the pressure-sensitive adhesive label, illustrating another modified example of the layout of the opening groups formed in the function layer.

FIG. 13 is a plan view of the pressure-sensitive adhesive label, illustrating another modified example of the layout of the opening groups formed in the function layer.

FIG. 14 is a configuration diagram of a printer including a pressure-sensitive adhesive label issuing device according to a second embodiment of the present invention.

FIG. 15 is a plan view of a pressure-sensitive adhesive label, illustrating a related-art layout of openings formed in a function layer.

FIG. 16 is a plan view of a heat generating element included in a thermal head, illustrating a temperature gradient at the time of heat generation.

FIG. 17 is a view illustrating a state in which the size of the openings is increased from the state illustrated in FIG. 15.

### DETAILED DESCRIPTION OF THE PREFERRED EMBODIMENTS

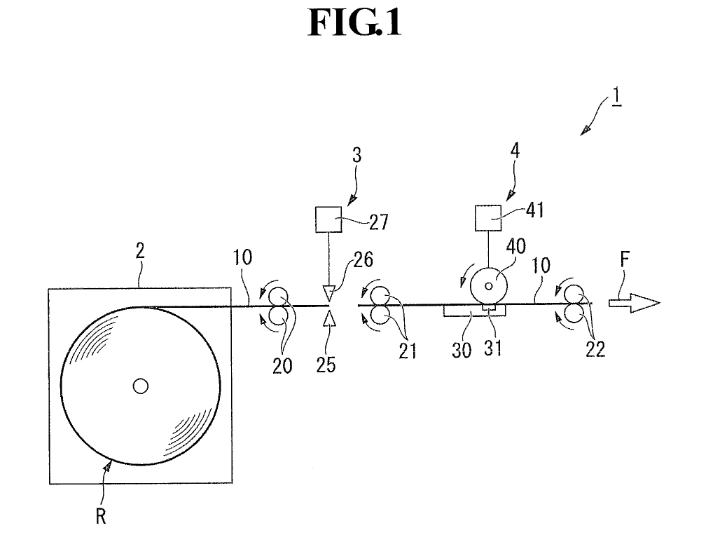

Now, a first embodiment of the present invention is described with reference to the accompanying drawings. As illustrated in FIG. 1, a pressure-sensitive adhesive label issuing device 1 according to this embodiment is a device configured to use roll paper R having a belt-shaped pressure-sensitive adhesive label 10 rolled therearound into a roll, cut the pressure-sensitive adhesive label 10 unrolled from the roll paper R to a predetermined length, and issue the pressure-sensitive adhesive label 10 in a state in which the pressure-sensitive adhesive label 10 expresses pressure-sensitive adhesive force. Note that, in this embodiment, in the state illustrated in FIG. 1, a conveyance direction of the pressure-sensitive adhesive label 10 is represented by an arrow F, the roll paper R side is the upstream side in the conveyance direction F (hereinafter simply referred to as “upstream side”), and the opposite side is the downstream side in the conveyance direction F (hereinafter simply referred to as “downstream side”).

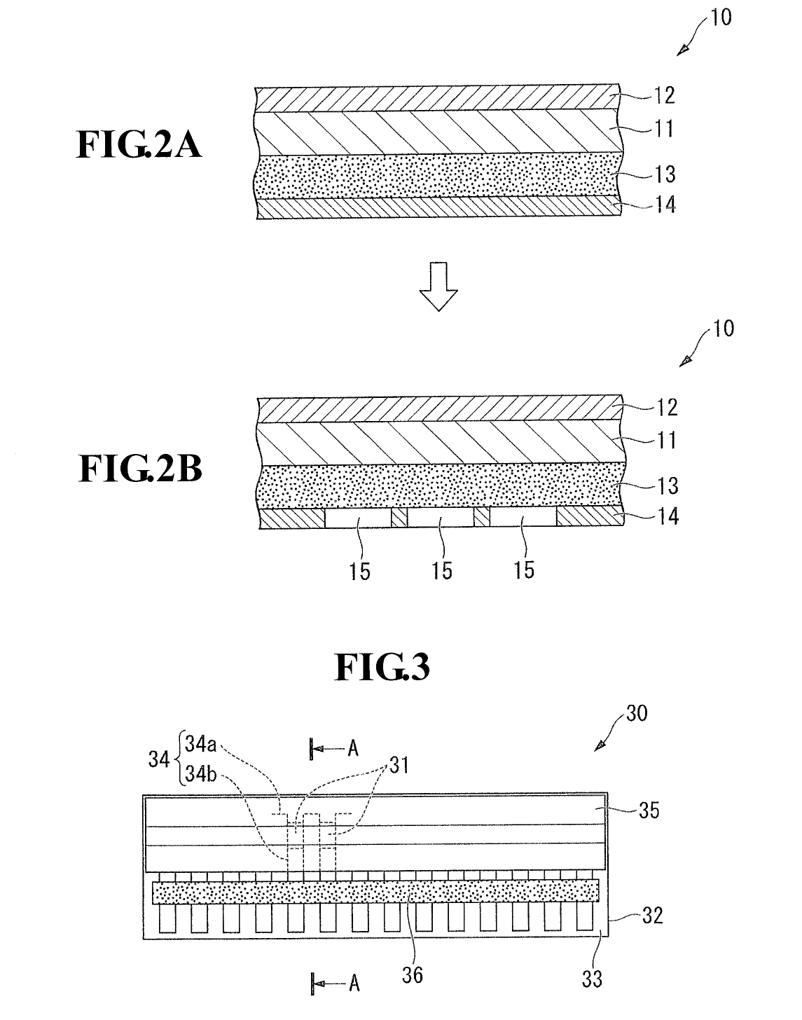

The above-mentioned roll paper R having the belt-shaped pressure-sensitive adhesive label 10 rolled therearound is received and held rotatably in a roll paper receiving portion 2 placed on the upstream side of the pressure-sensitive adhesive label issuing device 1. As illustrated in FIGS. 2A and 2B, the pressure-sensitive adhesive label 10 includes a base 11, a printable layer 12 laminated on one surface of the base 11, a pressure-sensitive adhesive layer 13 laminated on another surface of the base 11, and a non-pressure-sensitive-adhesive function layer 14 that covers the pressure-sensitive adhesive layer 13 to regulate pressure-sensitive adhesiveness thereof. Note that, in this embodiment, the printable layer 12 side of the pressure-sensitive adhesive label 10 is referred to as “front surface (one surface) side”, and the function layer 14 side thereof is referred to as “rear surface (another surface) side”.

The printable layer 12 is a thermosensitive recording layer that develops color by heating and is formed over the entire front surface of the base 11. The pressure-sensitive adhesive layer 13 is, for example, a layer made of a pressure-sensitive adhesive that expresses pressure-sensitive adhesiveness merely by being applied with a slight pressure at room temperature for a short period of time without using water, a solvent, or heat, and is formed over the entire rear surface of the base 11.

Note that, it is preferred that the above-mentioned pressure-sensitive adhesive have both cohesion and an elastic force and have high pressure-sensitive adhesiveness as well as being easily released. Note that, the pressure-sensitive adhesive layer 13 is not limited to the one made of a pressure-sensitive adhesive and may be, for example, the one made of a rubber-based pressure-sensitive adhesive such as natural rubber, styrene butadiene rubber (SBR), or polyisobutylene rubber; a non-crosslinking acrylic pressure-sensitive adhesive obtained by copolymerizing a monomer having a low glass transition point with a monomer having a high glass transition point; or a silicon-based pressure-sensitive adhesive made of silicon having high cohesion and silicon resin having high pressure-sensitive adhesive force.

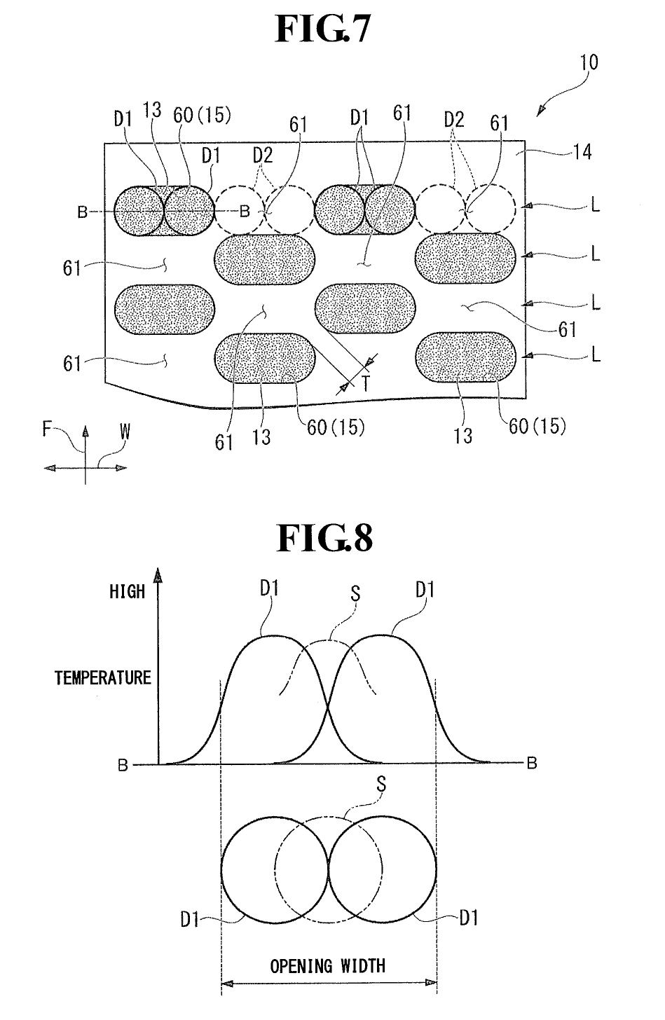

The function layer 14 covers the entire surface of the pressure-sensitive adhesive layer 13 and is formed of a thermosensitive film or the like in which minute openings (bores) 15 are formed by heating. The above-mentioned openings 15 are formed by being heated locally by heat generating elements 31 of a thermal head 30 to be described later. When the openings 15 are formed, the pressure-sensitive adhesive layer 13 is exposed outside, thereby expressing pressure-sensitive adhesive force. Note that, by connecting the openings 15 together, an opening group 60 (see FIG. 7) to be described later is formed.

The above-mentioned pressure-sensitive adhesive label issuing device 1 is now described. As illustrated in FIG. 1, the pressure-sensitive adhesive label issuing device 1 includes the above-mentioned roll paper receiving portion 2, first conveyance rollers 20 for conveying the pressure-sensitive adhesive label 10 unrolled from the roll paper R toward the downstream side while sandwiching the pressure-sensitive adhesive label 10 in the thickness direction, a cutter unit 3 for cutting the pressure-sensitive adhesive label 10 conveyed by the first conveyance rollers 20 to a desired length, second conveyance rollers 21 for conveying the cut pressure-sensitive adhesive label 10 toward the further downstream side while sandwiching the pressure-sensitive adhesive label 10 in the thickness direction, a pressure-sensitive adhesive force expressing unit 4 for heating the pressure-sensitive adhesive label 10 conveyed by the second conveyance rollers 21 from the function layer 14 side to cause the pressure-sensitive adhesive label 10 to express pressure-sensitive adhesive force, and third conveyance rollers 22 for conveying the pressure-sensitive adhesive label 10 expressing the pressure-sensitive adhesive force toward the further downstream side while sandwiching the pressure-sensitive adhesive label 10 in the thickness direction.

Note that, in this embodiment, a description is given of the case where the cutter unit 3 is placed on the upstream side of the pressure-sensitive adhesive force expressing unit 4. However, the present invention is not limited to this case, and the cutter unit 3 may be placed on the downstream side of the pressure-sensitive adhesive force expressing unit 4.

The cutter unit is a cutter mechanism including a fixed blade 25 and a movable blade 26 that are placed so that the blade edges may be opposed to each other across the pressure-sensitive adhesive label 10 in the thickness direction. The cutter unit is placed on the downstream side of the first conveyance rollers 20 and on the upstream side of the second conveyance rollers 21. The fixed blade 25 is placed on the rear surface side of the pressure-sensitive adhesive label 10, and the movable blade 26 is placed on the front surface side of the pressure-sensitive adhesive label 10. However, the fixed blade 25 may be placed on the front surface side of the pressure-sensitive adhesive label 10, and the movable blade 26 may be placed on the rear surface side of the pressure-sensitive adhesive label 10.

The movable blade 26 freely slides to approach or be separate with respect to the fixed blade 25 by being driven by a cutter drive unit 27, and can cut the pressure-sensitive adhesive label 10 while vertically sandwiching the pressure-sensitive adhesive label 10 between the movable blade 26 and the fixed blade 25.

The pressure-sensitive adhesive force expressing unit 4 includes the pressure-sensitive adhesive force expressing thermal head 30 for expressing pressure-sensitive adhesive force by heating the pressure-sensitive adhesive label 10 to form the minute openings 15 in the function layer 14, and a pressure-sensitive adhesive force expressing platen roller 40 for conveying the pressure-sensitive adhesive label 10 to the downstream side while sandwiching the pressure-sensitive adhesive label 10 between the thermal head 30 and the platen roller 40.

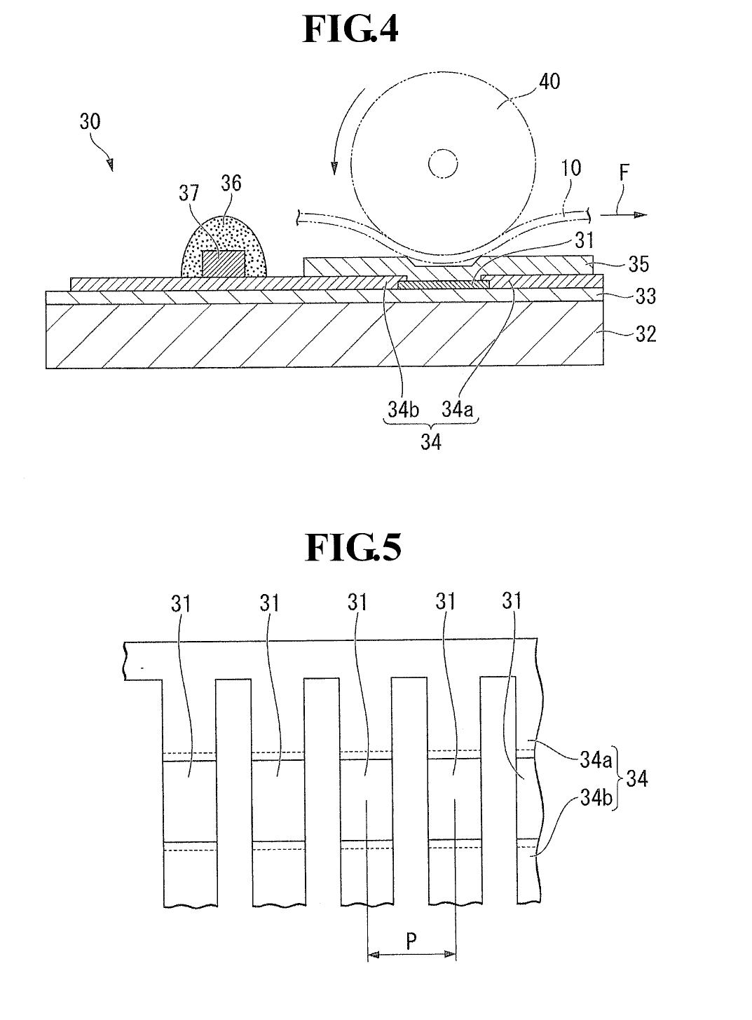

The thermal head 30 is a line thermal head that includes a plurality of heat generating elements 31 arranged in line along a width direction W of the pressure-sensitive adhesive label 10 (see FIG. 7) and is capable of heating the function layer 14 of the pressure-sensitive adhesive label 10 individually by the heat generating elements 31 and thereby forming the openings 15 in the function layer 14. The thermal head 30 is placed on the rear surface side of the pressure-sensitive adhesive label 10. Specifically, as illustrated in FIGS. 3 and 4, the thermal head 30 includes a ceramic substrate 32 serving as a heat radiation substrate, a glaze layer (heat storage layer) 33 laminated over the entire surface of the ceramic substrate 32, the heat generating elements 31 and an electrode portion 34 laminated on the glaze layer 33, and a protective layer 35 for protecting the heat generating elements 31 and a part of the electrode portion 34.

The ceramic substrate 32 is supported by a head support substrate (not shown), and is biased toward the platen roller 40 side by a coil spring (not shown) or the like to be brought into pressure contact with an outer peripheral surface of the platen roller 40. In this manner, the pressure-sensitive adhesive label 10 is in the state of being sandwiched between the thermal head 30 and the platen roller 40 to be pressed against the thermal head 30 (see FIG. 4).

The above-mentioned glaze layer 33 is a layer formed, for example, by firing printed glass paste at a predetermined temperature (for example, 1,300° C. to 1,500° C.). The heat generating element 31 is formed on the glaze layer 33, for example, by laminating a heating resistor made of Ta—SiO₂ or the like by sputtering or the like and thereafter patterning the heating resistor by photolithography or the like. In this case, as illustrated in FIG. 5, the heat generating elements 31 are arranged in line at predetermined equal pitches P (for example, 20 μm) along a longitudinal direction of the ceramic substrate 32. Note that, each heat generating element 31 has a substantially rectangular shape in plan view.

As illustrated in FIGS. 3 to 5, the electrode portion 34 is formed by laminating, for example, a layer of Al, Cu, or Au on the glaze layer 33 by sputtering or the like and then patterning the layer by photolithography or the like. The electrode portion 34 includes a common electrode part 34a that is electrically connected to all the above-mentioned plurality of heat generating elements 31, and individual electrode parts 34b that are electrically connected to the respective heat generating elements 31 individually. Thus, heat energy can be applied to each of the plurality of heat generating elements 31 through the electrode portion 34 to cause the heat generating element 31 to generate heat independently.

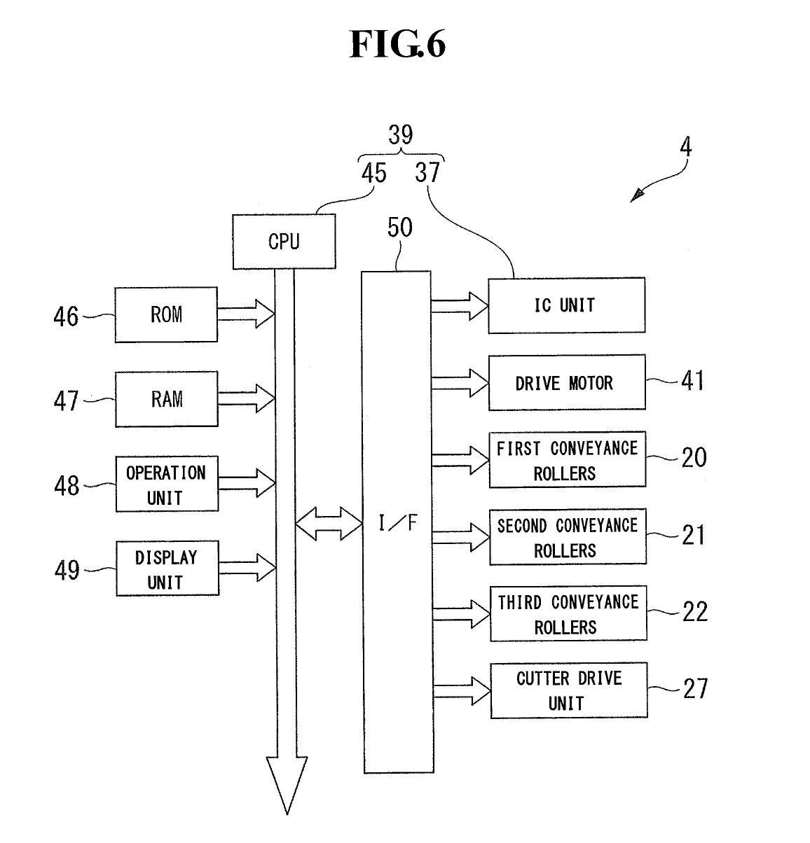

An IC unit 37 protected by a sealing portion 36 made of a resin or the like is mounted on each individual electrode part 34b. The IC units 37 cooperate with a CPU 45 (see FIG. 6) described later to control the heat generation of the heat generating elements 31. Thus, the IC units 37 and the CPU 45 serve to control the heat generation by applying heat energy to the plurality of heat generating elements 31 through the electrode portion 34.

The protective layer 35 is a layer for preventing oxidation and abrasion of the electrode portion 34 and the heat generating elements 31, and is formed of, for example, a hard metal oxide such as Si—O—N or Si—Al—O—N. Then, the protective layer 35 completely covers and protects the plurality of heat generating elements 31 and the common electrode part 34a, and covers and protects a part of the individual electrode parts 34b.

As illustrated in FIGS. 1 and 4, the platen roller 40 is a rubber roller to be rotated by a drive motor 41 whose driving is controlled by the CPU 45 described later, and is provided on the upper surface side of the pressure-sensitive adhesive label 10 to convey the pressure-sensitive adhesive label 10 to the downstream side while sandwiching the pressure-sensitive adhesive label 10 between the thermal head 30 and the platen roller 40.

Further, the pressure-sensitive adhesive force expressing unit 4 according to this embodiment includes, as illustrated in FIG. 6, the CPU 45, a ROM 46 having stored thereon a control program executed by the CPU 45 and other programs, a RAM 47 for storing formation pattern data and the like of the opening group 60 to be formed in the function layer 14, an operation unit 48 for inputting, setting, or invoking the formation pattern data and the like, a display unit 49 for displaying the formation pattern data and the like, and an interface unit (I/F unit) 50 for inputting and outputting data between the CPU 45 and the above-mentioned respective function units. The above-mentioned interface unit 50 is connected to the IC unit 37 of the thermal head 30, the drive motor 41 of the platen roller 40, the first to third conveyance rollers 20, 21, and 22, and the cutter drive unit 27 to control the operations thereof.

By the way, a control unit 39 including the CPU 45 and the IC unit 37 repeats the application of heat energy to the plurality of heat generating elements 31 along with the driving of the platen roller 40, thereby being capable of forming the plurality of openings 15 in the function layer 14 of the pressure-sensitive adhesive label 10 so as to express the pressure-sensitive adhesive force in a desired range thereof.

In particular, in order to express the pressure-sensitive adhesive force, as illustrated in FIG. 7, the control unit 39 controls the application of heat energy to the heat generating elements 31 so that a plurality of opening lines L in each of which a plurality of openings 15 are arranged in the function layer 14 of the pressure-sensitive adhesive label 10 along the width direction W may be formed continuously in the conveyance direction F.

In addition, in order to form each opening line L, the control unit 39 controls the application of heat energy to the heat generating elements 31 so that adjacent at least two of the plurality of heat generating elements 31 may generate heat at the same time to form the opening group 60 in which the openings 15 are connected together in the width direction W of the pressure-sensitive adhesive label 10.

Specifically, for each opening line L, two sets of adjacent two heat generating elements 31 sandwiching two heat generating elements 31 not to be controlled to generate heat are controlled to generate heat at the same time, to thereby form two sets of opening groups 60 with spaces in the width direction W. In this manner, for each opening line L, the opening groups 60 and non-opening parts 61 are arranged alternately in the width direction W of the pressure-sensitive adhesive label 10. In addition, the control unit 39 controls the application of heat energy so that the opening groups 60 and the non-opening parts 61 are arranged alternately also in the conveyance direction F of the pressure-sensitive adhesive label 10. In this manner, the opening groups 60 are formed in a checkered pattern over the entire surface of the function layer 14 of the pressure-sensitive adhesive label 10.

Note that, in FIG. 7, in the first opening line L, heat generating dots formed by heat generation of the heat generating elements 31 are represented by D1, and non-heat generating dots that are not applied with heat energy and generate no heat are represented by D2. Thus, the heat generating elements 31 are arranged correspondingly to the positions indicated by the heat generating dots D1 and the non-heat generating dots D2.

Next, a description is given of the case where the pressure-sensitive adhesive label issuing device 1 including the pressure-sensitive adhesive force expressing unit 4 configured as described above is used to issue the pressure-sensitive adhesive label 10 in the state of expressing pressure-sensitive adhesive force. Note that, this embodiment assumes that information has already been printed on the printable layer 12 at the stage when the pressure-sensitive adhesive label 10 is rolled as the roll paper R.

First, as a preliminary operation, the roll paper R is set in the roll paper receiving portion 2 in the state in which the pressure-sensitive adhesive label 10 is pulled out of the roll paper receiving portion 2, and thereafter the downstream end of the pulled-out pressure-sensitive adhesive label 10 is inserted between the first conveyance rollers 20. Further, necessary label information is input in advance to the control unit 39. Examples of the label information include the size of the width of the pressure-sensitive adhesive label 10 and the formation pattern data of the opening group 60 for expressing pressure-sensitive adhesive force. Then, when the operation starts, the control unit 39 operates the respective components sequentially.

Then, as illustrated in FIG. 1, the first conveyance rollers 20 rotate first, and the pressure-sensitive adhesive label 10 is conveyed to the downstream side to be supplied to the cutter unit 3. The pressure-sensitive adhesive label 10 is conveyed to the downstream side while passing between the fixed blade 25 and the movable blade 26. Then, when the pressure-sensitive adhesive label 10 has passed by a desired length, the control unit 39 operates the cutter drive unit 27 to slide and move the movable blade 26 toward the fixed blade 25. In this manner, the pressure-sensitive adhesive label 10 can be cut while being sandwiched between the movable blade 26 and the fixed blade 25, and the pressure-sensitive adhesive label 10 adjusted to a desired length can be obtained.

Note that, the method of detecting that the pressure-sensitive adhesive label 10 has passed by a desired length is, for example, a method involving using an optical sensor or a micro switch (not shown) or a method involving detection based on label length dimensions indicated by the label information and a calculated value of a label feed amount of the pressure-sensitive adhesive label 10.

Subsequently, the pressure-sensitive adhesive label 10 having passed through the cutter unit 3 is conveyed to the downstream side by the second conveyance rollers 21 to be delivered between the thermal head 30 and the platen roller 40 of the pressure-sensitive adhesive force expressing unit 4, and is conveyed to the downstream side while being pressed against the thermal head 30 by the platen roller 40.

In this period, the control unit 39 applies heat energy independently to the plurality of heat generating elements 31 of the thermal head 30, and hence each of those heat generating elements 31 generates heat with the amount of the applied heat energy. Consequently, the function layer 14 of the pressure-sensitive adhesive label 10 pressed against the thermal head 30 by the platen roller 40 can be locally heated only in regions in contact with the heat generating elements 31 via the protective layer 35. Then, the regions can be melted to form the openings 15, and the opening line L in which the openings 15 are arranged in the width direction W of the pressure-sensitive adhesive label 10 can be formed in the function layer 14. The pressure-sensitive adhesive layer 13 is exposed when the openings 15 are formed, and hence the pressure-sensitive adhesive force can be expressed.

Then, by repeating the application of heat energy to the plurality of heat generating elements 31 along with the conveyance of the pressure-sensitive adhesive label 10 by the platen roller 40, a plurality of the opening lines L can be formed in the function layer 14. In this manner, the pressure-sensitive adhesive force can be expressed in a desired region of the pressure-sensitive adhesive label 10.

By the way, in order to form each opening line L, as illustrated in FIG. 7, the control unit 39 controls the application of heat energy to the heat generating elements 31 so that adjacent two heat generating elements 31 may generate heat at the same time to form the opening group 60 in which the openings 15 are connected together in the width direction W of the pressure-sensitive adhesive label 10. This configuration can increase the temperature at an intermediate point located between the heat generating elements 31 applied with heat energy. Specifically, as shown in FIG. 8, the temperature in an intermediate region S located between two heat generating dots D1 formed by heat generation of the heat generating elements 31 can be increased to the same temperature as a peak temperature of the heat generating dots D1 owing to the effect of interaction of the increase in temperature of the respective heat generating dots D1. Note that, the above-mentioned intermediate region S is sandwiched between the two heat generating dots D1 and therefore expresses the same temperature tendency as that of the heat generating dots D1.

With this configuration, not only the region of the function layer 14 in contact with the heat generating elements 31 applied with heat energy but also the region in contact with the above-mentioned intermediate point can be melted. Thus, even without increasing the amount of heat energy to be applied, the function layer 14 can be melted in a wide area, and the opening group 60 having a large opening ratio in which the openings 15 are connected together in the width direction W can be formed.

Consequently, the function layer 14 can be melted locally at a sufficient opening ratio to expose the pressure-sensitive adhesive layer 13. Further, it is not necessary to increase the amount of heat energy to be applied to the heat generating elements 31, and hence the function layer 14 provided at the periphery of the opening group 60 can be prevented from being excessively melted. Thus, the strength of the function layer 14 can be secured to suppress the occurrence of tear. In view of the above, stable and sufficient pressure-sensitive adhesive force can be expressed in each opening group 60. Besides, the opening groups 60 can be formed in a checkered pattern over the entire surface of the function layer 14 of the pressure-sensitive adhesive label 10, and hence the stable and sufficient pressure-sensitive adhesive force can be uniformly expressed over the entire pressure-sensitive adhesive label 10. As a result, the pressure-sensitive adhesive label 10 can be stably adhered even with a low pressing force, and hence the quality as the pressure-sensitive adhesive label 10 can be enhanced.

Note that, the pressure-sensitive adhesive label 10 expressing the pressure-sensitive adhesive force is thereafter conveyed toward the downstream side by the third conveyance rollers 22 as illustrated in FIG. 1. In this manner, the pressure-sensitive adhesive label 10 can be issued in the state in which the pressure-sensitive adhesive force is expressed.

Further, according to the pressure-sensitive adhesive label issuing device 1 in this embodiment, the pressure-sensitive adhesive label 10 can be cut to a desired length by the cutter unit 3 and thereafter express stable and sufficient pressure-sensitive adhesive force by the pressure-sensitive adhesive force expressing unit 4, and hence the high quality pressure-sensitive adhesive label 10 can be issued.

Note that, in the above-mentioned embodiment, the pressure-sensitive adhesive label issuing device 1 includes the first to third conveyance rollers 20, 21, and 22, but those conveyance rollers are not essential but may be omitted, or three or more conveyance rollers may be provided depending on the conveyance path or the like. Further, the arrangement positions of the conveyance rollers may be freely set.

Further, in the above-mentioned embodiment, the opening groups 60 and the non-opening parts 61 are arranged alternately in both the width direction W and the conveyance direction F of the pressure-sensitive adhesive label 10 to thereby lay out the opening groups 60 in a checkered pattern, but the present invention is not limited to this case. The opening groups 60 may be arranged randomly in the width direction W and in the conveyance direction F. However, in the case where the opening groups 60 are laid out in a checkered pattern as exemplified in the above-mentioned embodiment, the number of times of heat generation can be made equal among the plurality of heat generating elements 31. Consequently, the non-uniformity of the life among the heat generating elements 31 can be eliminated, and the reliability of the operation of the pressure-sensitive adhesive force expressing unit 4 can be improved.

Further, the above-mentioned layout of the opening groups 60 in this embodiment is merely illustrative, and it is only necessary that, for each opening line L, adjacent at least two of the plurality of heat generating elements 31 be controlled to generate heat at the same time to form the opening group 60 in which the openings 15 are connected together in the width direction W. On that basis, a plurality of the opening groups 60 may be arranged with spaces in the width direction W and in the conveyance direction F, or the opening groups 60 may be connected together in the width direction W and in the conveyance direction F to form a single large opening group. Some specific examples of the layout of the opening groups are described below.

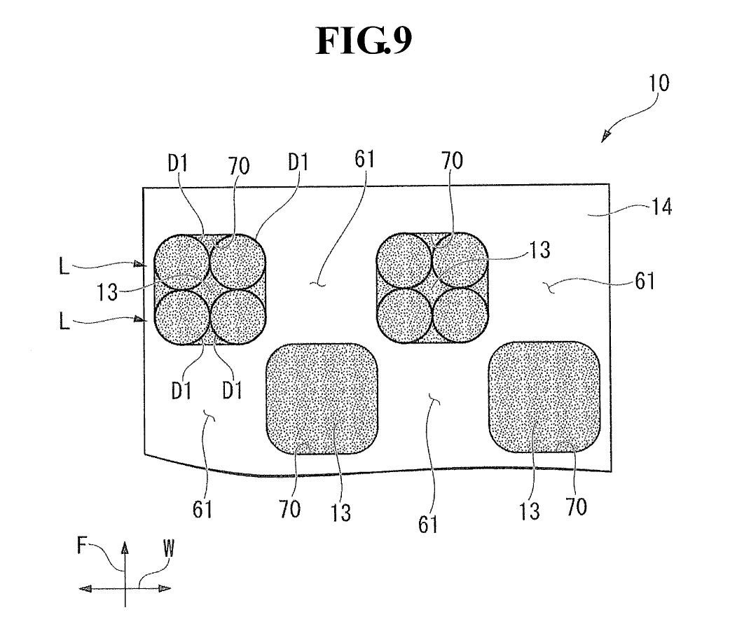

For example, as illustrated in FIG. 9, an opening group formed in the first opening line L and an opening group formed in the second opening line L may be connected together in the conveyance direction F to form an opening group 70 that is melted by four heat generating dots D1 (two in the width direction W by two in the conveyance direction F). Then, the opening groups 70 may be laid out and arranged in a checkered pattern in the width direction W and the conveyance direction F of the pressure-sensitive adhesive label 10. In this case, a larger opening ratio of the opening group 70 can be secured, and hence more stable pressure-sensitive adhesive force can be expressed.

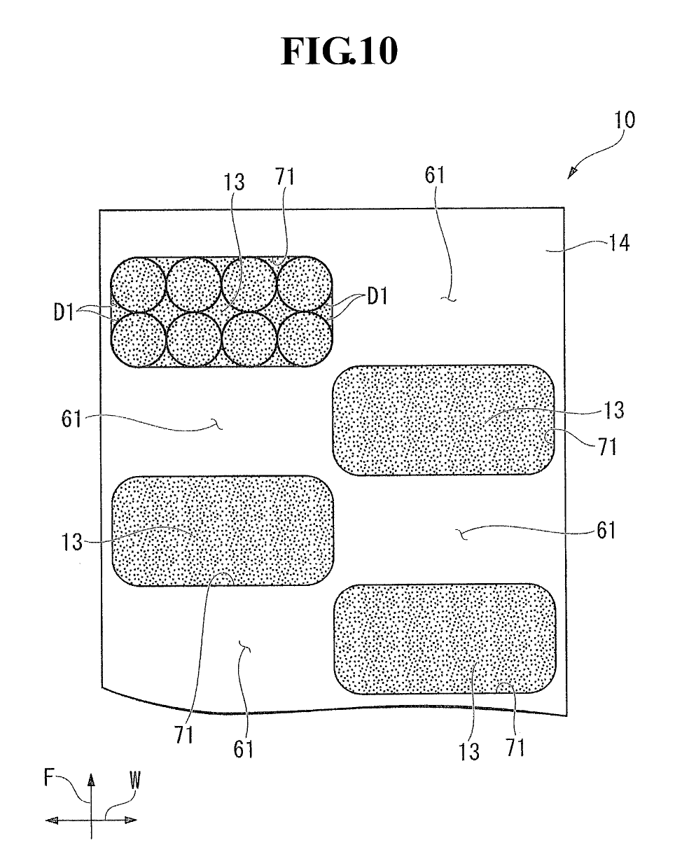

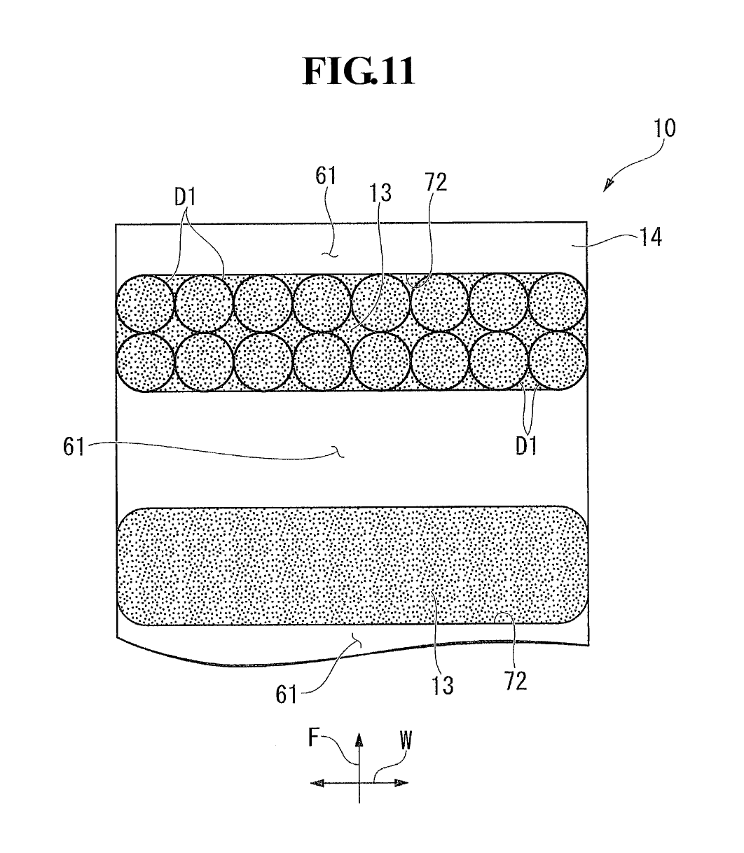

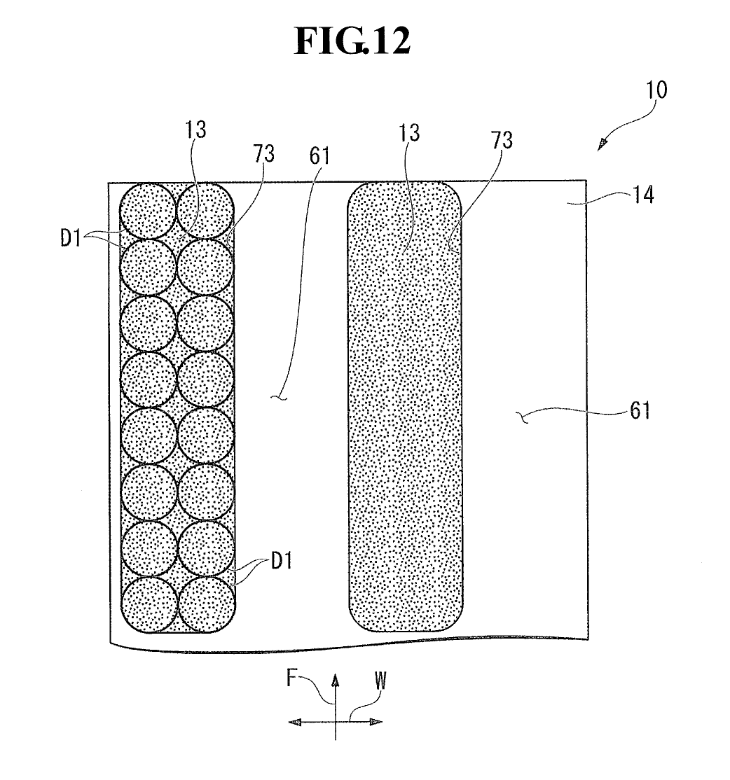

Alternatively, as illustrated in FIG. 10, an opening group 71 that is melted by eight heat generating dots D1 (four in the width direction W by four in the conveyance direction F) may be formed, and the opening groups 71 may be laid out and arranged in a checkered pattern in the width direction W and the conveyance direction F of the pressure-sensitive adhesive label 10. Alternatively, as illustrated in FIG. 11, an opening group 72 that is melted by sixteen heat generating dots D1 (eight in the width direction W by two in the conveyance direction F) may be formed, and the opening groups 72 may be laid out and arranged with spaces in the conveyance direction F of the pressure-sensitive adhesive label 10. Alternatively, as illustrated in FIG. 12, an opening group 73 that is melted by sixteen heat generating dots D1 (two in the width direction W by eight in the conveyance direction F) may be formed, and the opening groups 73 may be laid out and arranged with spaces in the width direction W of the pressure-sensitive adhesive label 10.

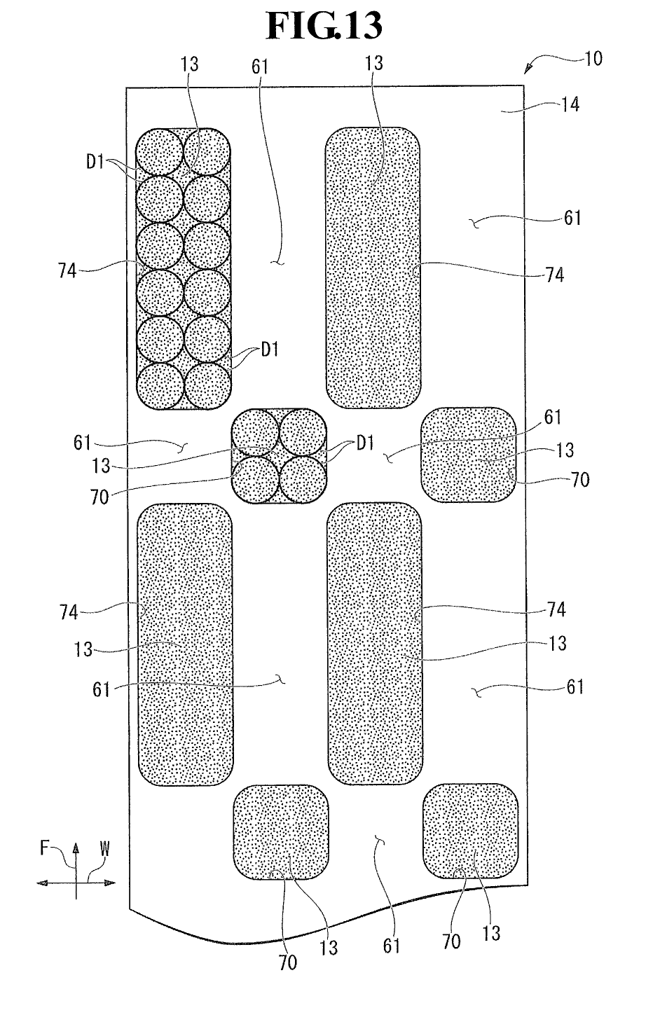

Still alternatively, as illustrated in FIG. 13, an opening group 74 that is melted by twelve heat generating dots D1 (two in the width direction W by six in the conveyance direction F) and the opening group 70 that is melted by four heat generating dots D1 (two in the width direction W by two in the conveyance direction F) may be formed, and the opening groups 74 and 70 may be laid out and arranged with certain regularity in the width direction W and the conveyance direction F of the pressure-sensitive adhesive label 10.

As described above, the layout of the opening groups may be freely designed as appropriate depending on, for example, the application, the size, and location of attachment of the pressure-sensitive adhesive label 10. Further, as illustrated in FIG. 7, it is preferred that adjacent opening groups 60 be spaced apart from each other by a gap T of 20 μm or more. With this configuration, higher strength of the function layer 14 can be secured, and hence such a problem that the function layer 14 is torn off when sliding with respect to the thermal head 30 during the conveyance can be easily prevented.

Next, a second embodiment of the present invention is described. Note that, in the second embodiment, the same components as those in the first embodiment are denoted by the same reference symbols to omit descriptions thereof

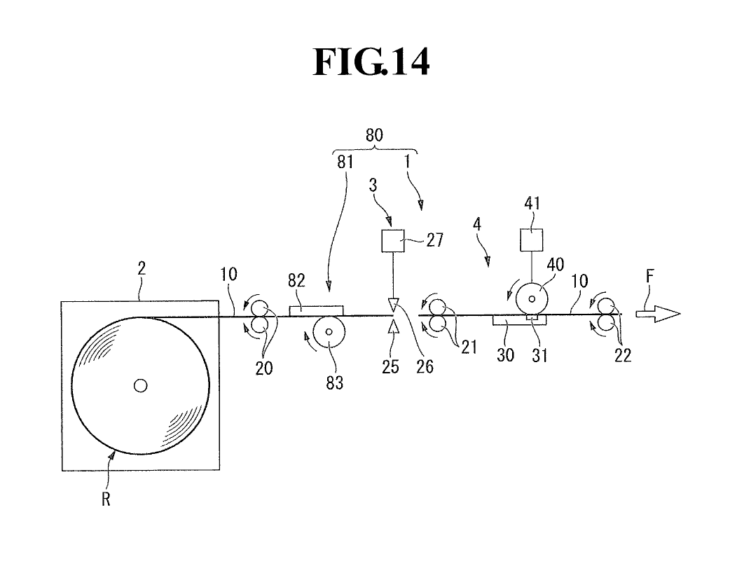

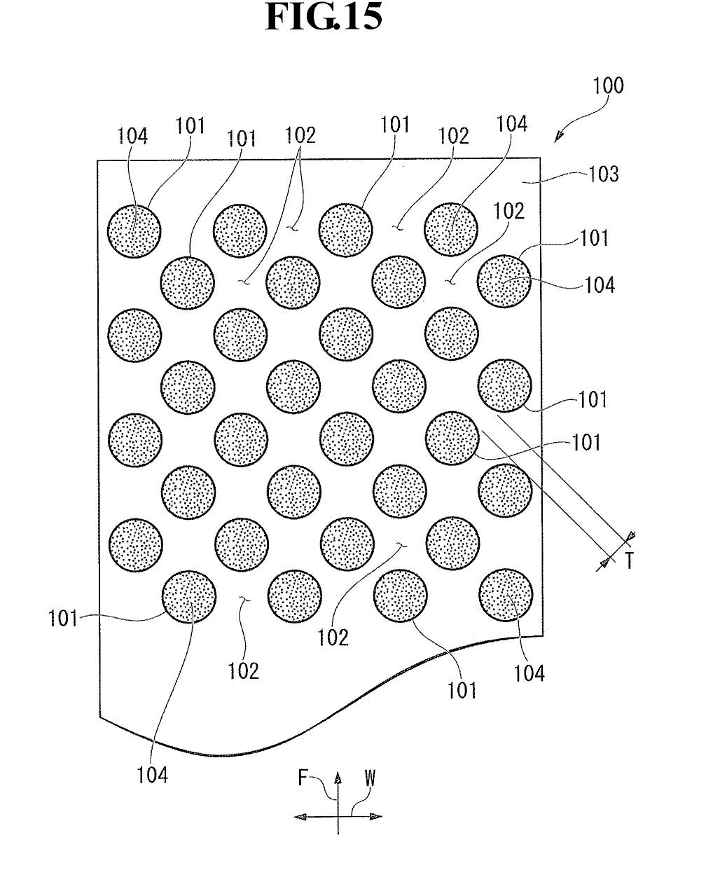

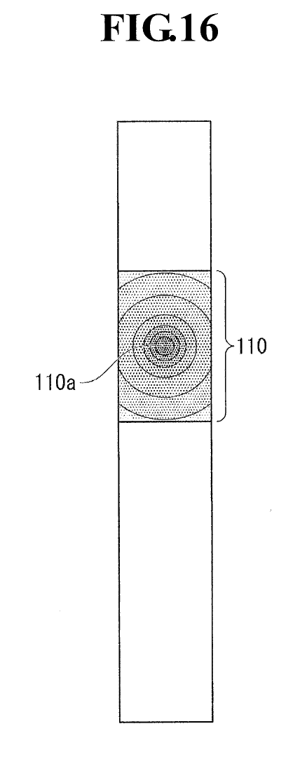

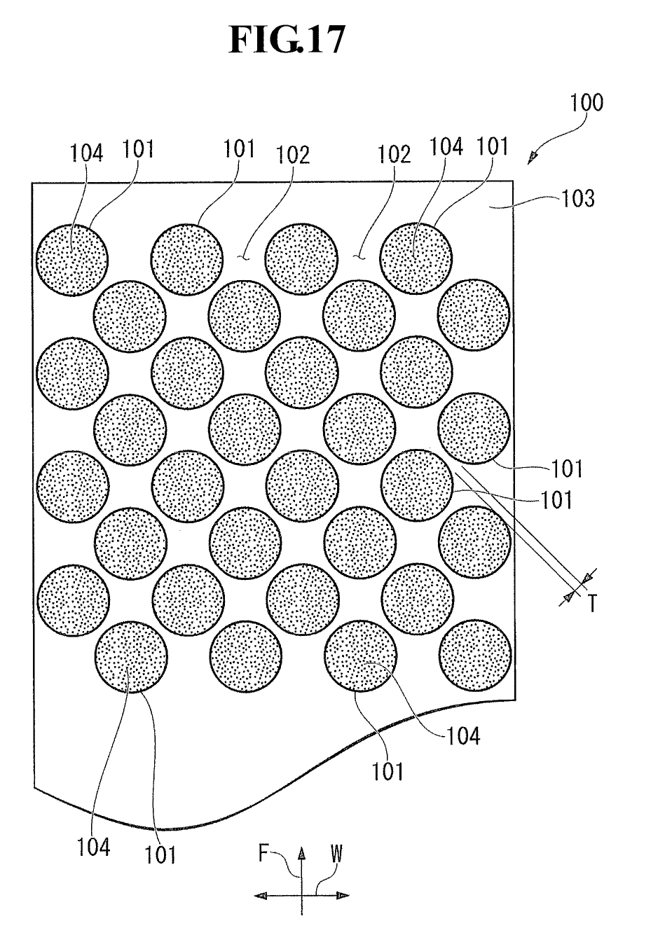

As illustrated in FIG. 14, a printer 80 according to this embodiment includes the above-mentioned pressure-sensitive adhesive label issuing device 1, and a printing unit 81 placed on the upstream side of the first conveyance rollers 20, for printing on the printable layer 12.

The printing unit 81 includes a printing thermal head 82 that includes heat generating elements (not shown) arranged in line and develops color by heating the printable layer 12 of the pressure-sensitive adhesive label 10 to print on the printable layer 12, and a printing platen roller 83 for conveying the pressure-sensitive adhesive label 10 to the downstream side while sandwiching the pressure-sensitive adhesive label 10 between the printing thermal head 82 and the printing platen roller 83. Note that, the printing thermal head 82 and the printing platen roller 83 have the same configurations as those of the thermal head 30 and the platen roller 40 of the above-mentioned pressure-sensitive adhesive force expressing unit 4, and the operations thereof are both are controlled by the CPU 45.

According to the printer 80 configured as described above, desired information can be printed on the printable layer 12 stably before pressure-sensitive adhesive force is expressed by the pressure-sensitive adhesive force expressing unit 4, and hence the high quality pressure-sensitive adhesive label 10 in which various kinds of information are clearly printed and stable and sufficient pressure-sensitive adhesive force is expressed can be obtained.

Note that, in this embodiment, the printing unit 81 only needs to be placed on the upstream side of the pressure-sensitive adhesive force expressing unit 4, and hence may be placed, for example, between the cutter unit 3 and the pressure-sensitive adhesive force expressing unit 4.

Note that, the technical scope of the present invention is not limited to that of the above-mentioned embodiments, and various kinds of modifications may be added within the range not departing from the gist of the present invention.

What is claimed is:

1. A pressure-sensitive adhesive force expressing unit that is configured to heat a pressure-sensitive adhesive label to express pressure-sensitive adhesive force thereof, the pressure-sensitive adhesive label including a printable layer and a pressure-sensitive adhesive layer, the printable layer being provided on one surface of a base, the pressure-sensitive adhesive layer being provided on another surface of the base and covered by a non-pressure-sensitive-adhesive function layer,
the pressure-sensitive adhesive force expressing unit including:
a thermal head including a plurality of heat generating elements arranged along a width direction of the pressure-sensitive adhesive label, the thermal head being configured to heat the pressure-sensitive adhesive label, which is conveyed along a conveyance direction, from the pressure-sensitive adhesive layer side to form openings in the non-pressure-sensitive-adhesive function layer by the plurality of heat generating elements and expose the pressure-sensitive adhesive layer; and
a control unit for applying heat energy to the plurality of heat generating elements individually to control heat generation thereof, the control unit being configured to control the application of heat energy to the plurality of heat generating elements so that a plurality of opening lines in each of which the openings are arranged in the width direction of the pressure-sensitive adhesive label are formed in the conveyance direction and to control, in order to form each of the plurality of opening lines, the application of heat energy so that adjacent at least two of the plurality of heat generating elements generate heat at the same time to form an opening group in which the openings are connected together in the width direction.

2. A pressure-sensitive adhesive force expressing unit according to claim 1, wherein
the control unit is configured to control the application of heat energy to the plurality of heat generating elements so that the opening groups are formed in a state in which each of the opening groups is connected to an opening group formed in a preceding opening line in the conveyance direction.

3. A pressure-sensitive adhesive force expressing unit according to claim 1, wherein
the control unit is configured to control the application of heat energy to the plurality of heat generating elements so that the opening groups and non-opening parts are arranged alternately in both the width direction and the conveyance direction.

4. A pressure-sensitive adhesive force expressing unit according to claim 1, wherein
the control unit is configured to control the application of heat energy to the plurality of heat generating elements so that adjacent ones of the opening groups are spaced apart from each other by 20 μm or more.

5. A pressure-sensitive adhesive force expressing unit according to claim 2, wherein
the control unit is configured to control the application of heat energy to the plurality of heat generating elements so that adjacent ones of the opening groups are spaced apart from each other by 20 μm or more.

6. A pressure-sensitive adhesive force expressing unit according to claim 3, wherein
the control unit is configured to control the application of heat energy to the plurality of heat generating elements so that adjacent ones of the opening groups are spaced apart from each other by 20 μm or more.

7. A pressure-sensitive adhesive label issuing device including:
the pressure-sensitive adhesive force expressing unit according to claim 1; and
a cutter unit for cutting the pressure-sensitive adhesive label to a desired length.

8. A printer including:
the pressure-sensitive adhesive label issuing device according to claim 7; and
a printing unit placed on an upstream side of the pressure-sensitive adhesive force expressing unit in the conveyance direction, for printing on the printable layer.
